(19) United States
(12) Patent Application Publication
(10) Pub. No.: US 2014/0081691 A1
(43) Pub. Date: Mar. 20, 2014

(54) SYSTEMS AND METHODS FOR WORKFLOW AUTOMATION

(71) Applicant: Morton Wendell, Dallas, TX (US)

(72) Inventor: Morton Wendell, Dallas, TX (US)

(21) Appl. No.: 14/031,937

(22) Filed: Sep. 19, 2013

Related U.S. Application Data
(60) Provisional application No. 61/703,636, filed on Sep. 20, 2012.

(51) Int. Cl. G06Q 10/06

(52) U.S. Cl. CPC G06Q 10/063114
USPC 705/7.15

(57) ABSTRACT

Systems and methods for workflow automation may be provided incorporating several functions including but not limited to management, communication, interoperability, and systematic workflow and resource management. When one or more tasks are to be completed, a ticket may be created including categorized tasks, each having a due date for completion and an assigned priority. As users perform tasks related to a ticket, a system for workflow automation may process and present statistics related to completion of the tasks, including but not limited to, time to completion, number of contacts to complete, and/or type(s) of contacts needed to complete. Systems and methods also may provide for auto-reprioritization, auto-routing and/or reassignment of tasks or tickets utilizing a team workload allocation algorithm and criteria including but not limited to workload, availability, expertise, familiarity with other users assigned to the ticket, as well as time-to-completion associated with different users of the system.

### CROSS-REFERENCE TO RELATED APPLICATION

The present application claims the benefit of U.S. Provisional Application No. 61/703,636 entitled “Systems and Methods for Workflow Automation,” filed Sep. 20, 2012, the disclosure of which is hereby incorporated by reference in its entirety.

### FIELD OF THE DISCLOSURE

The present disclosure generally relates to systems and methods for workflow automation.

### BACKGROUND

Within any organization, many communications or operational functions are conducted through e-mail, phone and/or organization-specific web portals. When group mailboxes are available, they are usually congested and may not capture all forms of communication that may exist within the organization. As such, assignment of tasks or operations/actions to be taken with respect to a task, depending on the method used to communicate, may not reach all persons working on a given task. Further, several persons working on the same task may not be made aware of operations/actions taken with respect to the task, or persons may not have equivalent access to information that may be needed to complete the task. For example, if one person working on the task has reached his/her capacity workload and passes off responsibility to another person, the other persons working on the same task may not be aware that such a reassignment has been made. In some instances, it also may not be possible to identify when one person is overburdened and may need tasks to be reassigned.

### SUMMARY

Systems and methods for workflow automation according to embodiments of the present disclosure may be provided incorporating several functions including but not limited to management, communication, interoperability, and systematic workflow and resource management. When one or more tasks are to be completed, a ticket may be created including categorized tasks, each having a due date for completion and an assigned priority. As users perform tasks related to a ticket, systems and methods according to embodiments of the present disclosure may retain statistics related to completion of the tasks, including but not limited to, time to completion, number of contacts to complete, and/or type(s) of contacts needed to complete.

Systems and methods according to embodiments of the present disclosure also may provide for auto-reprioritization, auto-routing and/or reassignment of tasks or tickets utilizing a team workload allocation algorithm. Such systematic workflow and resource management may utilize criteria including but not limited to workload, availability, expertise, familiarity with other users assigned to the ticket, as well as time-to-completion associated with different users of the system.

Embodiments of the present disclosure may provide a web-based system for workflow automation comprising a relationship window providing an identification of a least one client being managed by the system at a specified time, a task window displaying information about tasks being performed by users within the system, the tasks being managed by the system, an open ticket window displaying a listing of open tickets within the system, and a priority level window to identify the priority level of the tasks assigned to users within the system and to evaluate whether additional tickets should be assigned to a selected user, wherein each of the windows is populated using information stored in one or more databases accessible via one or more web servers. Each of the windows may be selectively filterable.

The system may further comprise a response window wherein the users respond to address a selected ticket. The response window may display at least one ticket number and includes one or more items associated with the at least one ticket number selected from the list comprising counterparty, ticket description, contact, status, due date, due time, and ticket age. The at least one ticket number displayed in the response window may be color-coded to reflect the priority level of the ticket associated with the at least one ticket number at the time when a user responds to address the ticket. The response window may further comprise a text box wherein a user inputs a status message and transmits the message through at least one communication mode selected from the list comprising email, phone, text message, and chat.

The open ticket window may be organized as a table including a ticket number column and one or more columns selected from the list comprising client, ticket description, contact, status, due date, due time, and ticket age. The ticket number column may be color-coded to reflect the priority of the ticket associated with each ticket number. The color-coding may correlate to how quickly the deliverable associated with the ticket number is due or it may correlate to an estimated amount of time needed to complete the ticket relative to the due date.

The priority level window may identify one or more users and a status associated with each of the identified one or more users. The system also may include a log window that provides a log of actions taken as to each of the tickets that are open within the system. The system may further comprise a ticket window accessed by selecting an open ticket within the open ticket window. Information associated with each of the windows may be output to one or more interoperable systems operating external from the system.

Other embodiments of the present disclosure may provide a computer-based method for workflow automation comprising using one or more servers operating within a communication network, generating at least one ticket having at least one categorized task, each of the at least one categorized tasks being assigned a due date for completion and a priority status, and assigning the ticket to a user based on one or more factors selected from the group comprising internal priority, external priority, deadline, what number of contact the user is on, and average time to complete a task relative to the deadline. The method may further comprise managing metrics related to completion of the at least one categorized task, the metrics comprised of time to completion, number of contacts needed to complete, and types of contacts needed to complete, each of the metrics being stored in one or more databases residing on the one or more servers. The managing metrics step may comprise reassigning the at least one categorized task to a different user based on evaluation of each of the metrics associated with the at least one categorized task.

Further embodiments of the present disclosure may provide a computer-based method for workflow automation comprising using one or more servers, evaluating and changing the priority of the tasks within a user's task list based on workload, availability, expertise, familiarity with other users assigned to the task, and time-to-completion associated with each user assigned to the task, wherein the user's task list is stored in one or more databases residing on the one or more servers. The method may further comprise alerting the user to a task within the user's task list, and providing the user with means to respond to the alert, the alerting and providing steps being performed through a communication mechanism selected from the group comprising electronic mail, text message, phone call, and chat. The method also may comprise providing one or more communication mechanisms to transmit updates about a task to a user. The updates may be selected from one of the group comprising change in due date, change in due time, change in users assigned to the task, change in availability of users assigned to the task, workload of users assigned to the task, activities that have occurred related to the task, and change in task description.

### BRIEF DESCRIPTION OF THE DRAWINGS

For a more complete understanding of this disclosure, reference is now made to the following description, taken in conjunction with the accompanying drawings, in which:

FIG. 1 depicts a main screen within a system for workflow automation according to an embodiment of the present disclosure;

FIG. 2 depicts a ticket window within a system for workflow automation according to an embodiment of the present disclosure;

FIG. 3 depicts a management module within a system for workflow automation according to an embodiment of the present disclosure;

FIG. 4A depicts a pop-up window within a system for workflow automation that may provide a user with an alert related to a given ticket according to an embodiment of the present disclosure;

FIG. 4B depicts a pop-up window within a system for workflow automation that may provide a user with an update related to a previous action taken by the user according to an embodiment of the present disclosure;

FIG. 4C depicts a pop-up window within a system for workflow automation that may depict a reminder for a user assigned to a ticket according to an embodiment of the present disclosure;

FIG. 4D depicts a pop-up window within a system for workflow automation that may provide a notification of an incoming communication related to a ticket according to an embodiment of the present disclosure; and

FIG. 4E depicts a pop-up window within a system for workflow automation that may provide another means to remind a user that action or attention needs to be given to a ticket according to an embodiment of the present disclosure.

### DETAILED DESCRIPTION

Embodiments of the present disclosure may provide systems and methods for workflow automation. Tasks and communications may be managed within these systems, and the systems may calculate, process and retain statistics about tasks or tickets and utilize these statistics to suggest changes in workflow that may boost user efficiency. Systems and methods according to embodiments of the present disclosure may incorporate several functions including but not limited to management, communication, interoperability, and systematic workflow and resource management.

In embodiments of the present disclosure, when one or more tasks are to be completed, a ticket may be created within a workflow automation system. Tickets may include categorized tasks, each having a due date for completion and an assigned priority. As tasks may have associated deadlines for completion, tasks may auto-age as they approach their respective deadlines according to embodiments of the present disclosure. In an embodiment of the present disclosure, colors may be assigned to correlate to the amount of time left to complete the task before the deadline as will be described in more detail below.

It should be appreciated that tickets may be sent through the system to a specific user or to a group address according to embodiments of the present disclosure. As one or more users address tasks related to a ticket, the system may retain statistics related to completion of the tasks, including but not limited to, time to completion, number of contacts to complete, and/or type(s) of contacts needed to complete.

Systems and methods according to embodiments of the present disclosure also may provide for auto-reprioritization, auto-routing and/or reassignment of tasks or tickets through systematic workflow and resource management utilizing individual and/or team workload allocation algorithms. In a one-user scenario, a user's queue or task list may be managed and determinations may be made as to the priority of the tasks within the user's queue based on various criteria including but not limited to workload, availability, expertise (such as in relation to a task within a ticket), familiarity with other users that may be assigned to the ticket, as well as time-to-completion associated with different users of the system according to embodiments of the present disclosure. In a team scenario, individual user queues may be managed and determinations may be made based on similar criteria as set forth in the one-user scenario. For example, if a user assigned to a ticket is unavailable at a given time but should have availability to complete tasks associated with that ticket before the deadline, systems and methods according to embodiments of the present disclosure may permit the tasks to queue in a user's workflow, and the user then may be paired with the task when he/she available to perform the task. In the team scenario, automatic reassignment of tickets may occur to balance or optimize the workload of the team based on various criteria previously described as well as based on a load factor (or appropriateness) score according to embodiments of the present disclosure. In embodiments of the present disclosure, tickets may be color-coded based upon a workload allocation algorithm.

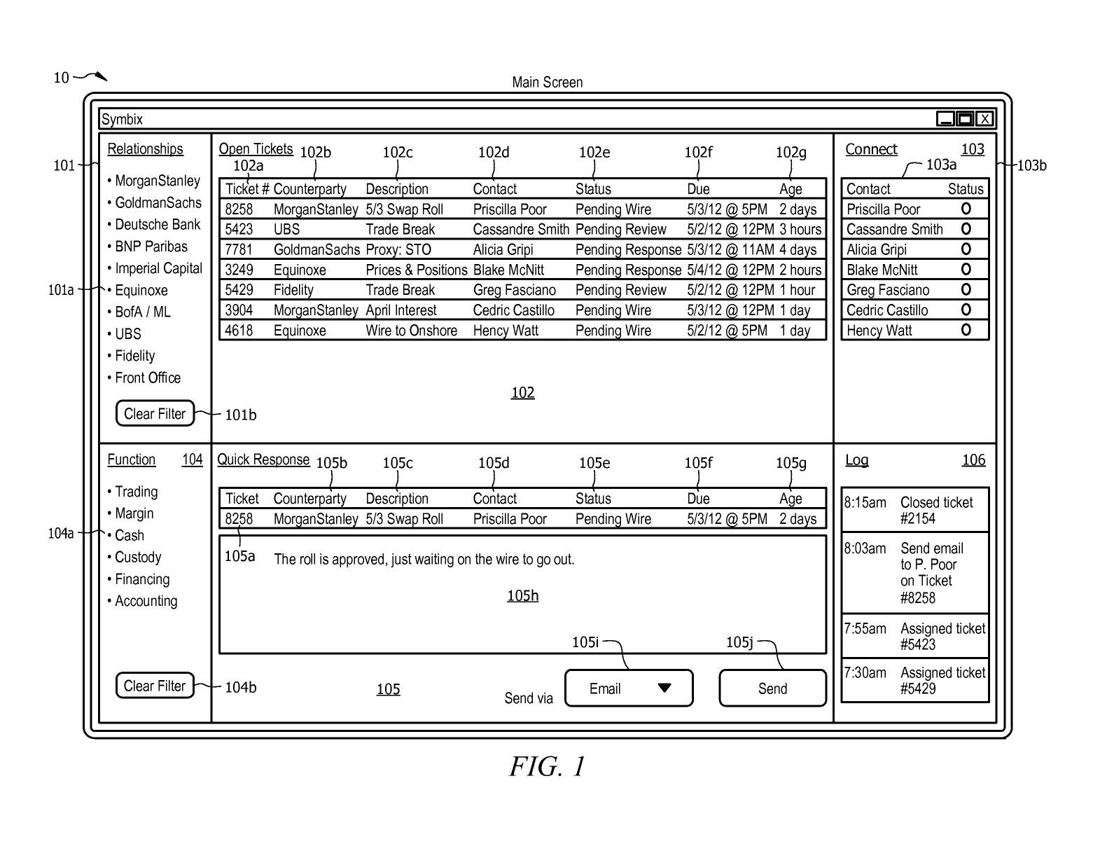

FIG. 1 depicts main screen 10 within a system for workflow automation according to an embodiment of the present disclosure. Main screen 10 may include one or more windows to provide information to a user about workflow and status within the system. While various windows are depicted in FIG. 1, it should be appreciated that more or fewer windows may be included as part of main screen 10 without departing from the present disclosure. Further, the windows may be arranged in different configurations on main screen 10 according to embodiments of the present disclosure.

Window 101 may depict information about the relationships (or clients, projects, or accounts) that may be managed within the system. List 101a may include the names of different clients or projects that may be managed by the system at any given time. It should be appreciated that list 101a may include as few as one item as part of the list or may include ten items or even more without departing from the present disclosure. It also should be appreciated that list 101a may be filterable according to various parameters as directed by the user manipulating the system. If a filter has been applied, a user may clear the filter by use of clear filter button 101b. In embodiments of the present disclosure, items within list 101a may be selectable, for example, via hyperlinks in order to filter items based upon user preference or need at any given time. However, other mechanisms for filtering relationships within window 101 may be utilized without departing from the present disclosure. It also should be appreciated that a button or other selection mechanism may be included within window 101 to permit a user to “lock in” any specified filters according to embodiments of the present disclosure. In other embodiments, such a button or other selection mechanism may be included in another window on main screen 10.

Window 104 may depict information about functions or tasks that may be performed by users within a workflow system and that are being managed by the system. List 104a may include an identification of different functions or tasks that may be performed by users of the system. It should be appreciated that list 104a may include as few as one item within the list or may include ten or even more items without departing from the present disclosure. It also should be appreciated that list 104a may be filterable according to various parameters as directed by a user operating with the system. If a filter has been applied, a user may clear the filter by use of clear filter button 104b. In embodiments of the present disclosure, items within list 104a may be selectable, for example, via hyperlinks in order to filter items based upon user preference or need. However, other mechanisms for filtering relationships within window 104 may be utilized without departing from the present disclosure. It also should be appreciated that a button or other selection mechanism may be included within window 104 to permit a user to “lock in” any specified filters according to embodiments of the present disclosure. In other embodiments, such a button or other selection mechanism may be included in another window on main screen 10.

Window 102 may include information about open tickets that are being managed within the system. In some embodiments of the present disclosure, window 102 may be organized as a table listing various items including but not limited to ticket number 102a, counterparty (or client) 102b, ticket description 102c, contact 102d, status 102e, due date/time 102f and ticket age 102g. It should be appreciated that more or fewer items may be included in window 102 without departing from the present disclosure. It also should be appreciated that, should a table form be used to display information about open tickets, the items may be organized in different orders without departing from the present disclosure and may be configured such that it can be sorted, for example, by column. In an embodiment of the present disclosure, entries within the column designated ticket number 102a may be highlighted using various colors that may indicate the priority of the ticket. As depicted in FIG. 1, four different colors have been applied to entries within the column, ticket number 102a. In an embodiment of the present disclosure, a red highlight may indicate a ticket that has highest priority, with orange, yellow and green indicating lessening degrees of priority, such as based on age of the ticket. However, colors that are utilized within the system may vary according to parameters set within each system. It should be appreciated that in some embodiments, the colors may correlate to how quickly the deliverable related to a ticket is due. In other embodiments, the colors may correlate to an estimated amount of time needed to complete the ticket relative to the due date. Regardless what colors are used within a system, the color-coding may be communicated to system users so that a user may appreciate the level of priority afforded to a given color associated with a ticket and address the ticket accordingly.

Window 103 may provide a mechanism to identify the priority level of the tickets assigned to any particular user(s) within the system. As depicted in FIG. 1, the entries may be organized in a tabular form and the table may include contact 103a and status 103b. Accordingly, for each contact/user 103a within the system, it may be possible to correlate status 103b to each contact. This information contained in window 103 may provide a real-time indication of whether additional tickets should be assigned to a given contact. For example, if red is the highest priority color and green is the lowest priority color within the system, then the information contained in window 103 may indicate that no additional tickets should be assigned to Priscilla Poor (red status); however, there may be other users that may be able to receive and work on additional tickets. In other embodiments of the present disclosure, the system may suggest tickets for different users to address based upon a user adjustable urgency algorithm that may consider factors including but not limited to internal priority, external priority, deadline, what number of contact the user is on (such as relative to the average number of contacts to complete the type of task assigned), and/or average time to complete a task relative to the deadline. Accordingly, the colors associated with contacts 103a may correlate to one or more of these factors.

Window 105 may provide a mechanism for users to quickly respond to address a selected ticket. Window 105 may include a table having entries related to selected ticket 105a including but not limited to counterparty 105b, ticket description 105c, contact 105d, status 105e, due date/time 105f, and age 105g. It should be appreciated that ticket 105a may be highlighted in a color to reflect the priority level of that ticket at the time when a user is accessing that ticket as has been previously described. Also, as discussed with respect to window 102, it should be appreciated that the table may include more or fewer columns without departing from the present disclosure. Window 105 may communicate with window 102 wherein a particular ticket (such as ticket 8258) may be selected from window 102 via hyperlink or another selection mechanism in order to provide a quick response via window 105. Once the ticket has been selected in window 102, it may then appear in window 105. Accordingly, a user may insert a response in box 105h to provide others assigned to the ticket or a manager with an update on the status of work being done with respect to the ticket. For example, the user listed as contact 105d may be supervising another user working on the ticket, and the user being supervised may provide the quick response on the ticket. Following entry of a response via box 105h, the user making the entry may elect to send the response via various communication mechanisms that may be selected via dropdown 105i. As depicted in window 105, a user may send a quick response via email; however, in other embodiments of the present disclosure, a user may be provided with other communication options including but not limited to phone, text message or chat without departing from the present disclosure. Once the user has completed his/her message and selected the mode of communication to transmit the message, the user may select send button 105j to transmit the message to relevant recipients. It should be appreciated that the recipients of the quick response may be predetermined based on the ticket that is at issue. However, in other embodiments, window 105 may be configured to include a selection mechanism to specifically select recipients of the message.

Window 106 may provide a log of actions that have been taken with respect to different tickets that have been opened within the system. As depicted in window 106, the log may be ordered based on the time when an action was taken. Actions may include but are not limited to closing a ticket, sending a communication related to a ticket, and/or assigning a ticket. In other embodiments of the present disclosure, the log may be configured such that it may be re-sorted based on ticket number or the type of action that has been taken (i.e., tickets that have been closed or assigned).

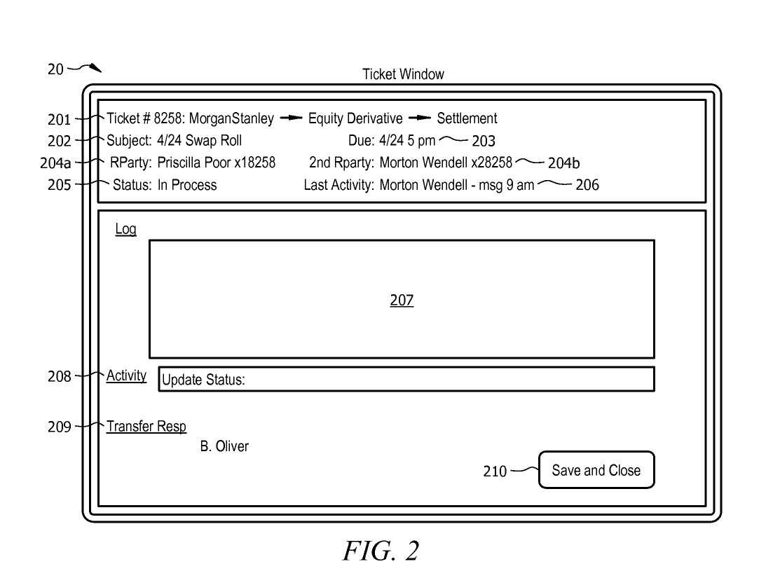

FIG. 2 depicts ticket window 20 according to an embodiment of the present disclosure. Ticket window 20 may be viewed, for example, by selecting one of the open tickets identified in window 102. In another embodiment, ticket window 20 may appear when a user seeks to create a new ticket. Ticket window 20 may include ticket identifier 201. Ticket identifier 201 may provide information including but not limited to the ticket number and a description of the general subject matter of the ticket at issue. It should be appreciated that this description may include a category as well as sub-categories of information depending on how the system is organized. In some embodiments of the present disclosure, ticket window 20 also may include subject 202 that may provide more specific information about the functions or tasks associated with the ticket. Due date 203 may be included on ticket window 20 and may include a specific date (day, month and/or year) and/or a specific time of day that the ticket should be completed according to embodiments of the present disclosure.

Ticket window 20 also may provide an identification of one or more responsible parties 204a, 204b. It should be appreciated that responsible parties may be depicted as primary and secondary responsible parties. It also should be appreciated that more than two responsible parties may be designated according to embodiments of the present disclosure and accordingly more than two spaces would be made available in window 20 to identify these users. In other embodiments of the present disclosure, there may only be one responsible party for a ticket, and accordingly, one space might be left blank.

The current state of the ticket may be reflected in status 205. Status 205 may include a dropdown box that may permit a user to change the status of the ticket by selecting one of a series of preselected status identifiers in an embodiment of the present disclosure. In other embodiments of the present disclosure, status 205 may provide a text box for the user to enter a desired status identifier, either from a series of status identifiers identified by the system for use or a self-inputted status identifier.

The latest activity that has occurred related to the ticket may be reflected in last activity 206. Last activity 206 may provide information including not limited to the user who performed the latest activity related to the ticket, the substance of the activity taken related to the ticket, and/or the date/time when the activity was performed. While last activity 206 is depicted as a text box, it should be appreciated that last activity 206 may include one or more dropdown fields that may be predetermined, in whole or in part, related to a particular ticket or tailored to the organizational interests.

Ticket window 20 also may include log 207 that may provide a list of the different tasks or actions that have been taken with respect to a ticket. Log 207 may include a listing of every task/action taken in some embodiments of the present disclosure. In other embodiments of the present disclosure, if many tasks/actions have been taken with respect to a ticket, log 207 may include only the most recent tasks/actions (i.e., the last 3-5 actions). In such embodiments, the user may be provided with a mechanism to select a view wherein all tasks or actions taken with respect to a ticket may be viewable or scrollable within ticket window 20 or via another pop-up window within the system.

Activity 208 may provide a user with a text box to update the status of tasks or activities performed with respect to a given ticket. In some embodiments of the present disclosure, activity 208 may provide a dropdown menu for a user to select from a predetermined list of updates and/or provide a self-entered status update.

Transfer 209 may provide a user of ticket window 20 with the ability to transfer responsibility for a given ticket to another user within the system. The input mechanism associated with transfer 209 may include but is not limited to a text box, a dropdown menu or a scroll listing of users. When a user has completed his/her modifications or inputs into ticket window 20, the user may select button 210 to save the information and close the window. However, other mechanisms may be provided to lock in the update without departing from the present disclosure.

It should be appreciated that having a ticket open (i.e., having ticket window 20 open) may automatically change the user's status to busy in some embodiments of the present disclosure. Accordingly, the system may be configured to not push alerts to that user to work on other tickets (such as with the exception of phone calls) according to some embodiments of the present disclosure.

Systems and methods according to embodiments of the present disclosure may provide for management of actions related to various tasks or tickets, including but not limited to issue tracking, logging and improved responsible party handoffs. Management through systems according to embodiments of the present disclosure may be performed related to tasks or tickets that originate either internal or external to an organization. As such, systems according to embodiments of the present disclosure may provide for permissioning in order for tickets associated with tasks or activities to be shared within an organization as well as shared with external administrators or other outside users.

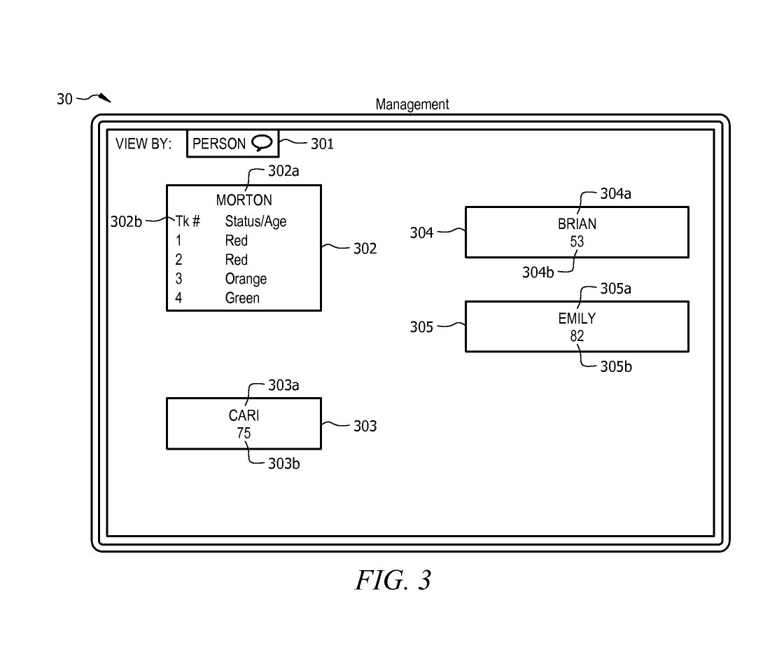

A management module may be provided within systems and methods according to embodiments of the present disclosure. Such a management module may provide a “hive view” allowing a manager to view and address how tickets are aging such as based on user groupings as will be described in more detail below with respect to FIG. 3. Accordingly, a manager may see if a user is overburdened with tasks or has availability to perform more tasks. If a user appears to be overburdened (i.e., having a large number of tasks relative to other users, many high priority tasks, and/or the expected completion time of all tasks due on a given day is past the end of the workday), then the system may provide for re-routing of tickets to other users in the “hive” based on a team workload allocation algorithm that may be established by the system. If all of the users within the system (or within the “hive”) are identified as overburdened, the system may auto-ask defined backups to join the “hive” and share responsibility for completion of tasks to rebalance the workload and increase the likelihood that tasks may be completed in a timely manner utilizing the resources that can be available. In this “hive view,” reporting of statistics based on users and tickets may be provided so that a manager may evaluate individual user performance according to embodiments of the present disclosure.

FIG. 3 depicts management module 30 according to an embodiment of the present disclosure. Management module 30 may be presented to a user through a pop-up window or through a separate screen that may be selected, for example, through main screen 10. Various views may be selected through selector 301, and in this embodiment, management module 30 is depicted to show tickets and their associated statuses on a user-by-user basis. However, a user may alter the view through selector 301 that may permit changes through use of a dropdown menu or other selection mechanism according to embodiments of the present disclosure. In this embodiment, four users are depicted each in a separate box within management module 30; however, more or fewer users may be depicted as part of management module 30 without departing from the present disclosure.

Box 302 may represent information pertaining to a first user in the system. In this embodiment, first user 302a has four tickets assigned to him represented in table 302b, and table 302b may be sorted or arranged to identify each ticket for which first user 302a has responsibility and the status/age associated with each ticket. It should be appreciated that the status/age may be set to “auto-age” insofar as, when a ticket is created, the creator may set a deadline for a ticket, and the priority level may change the closer that the ticket age gets to the set deadline. In this embodiment, first user 302a is depicted as having responsibility for two tickets that are red (which in this embodiment reflects highest priority), one ticket that is orange (which in this embodiment reflects a lower priority level than red) and one ticket that is green (which in this embodiment represents the lowest priority level). The system may evaluate the priority levels of the tickets assigned to first user 302a and move to another user who may have responsibility for tickets with a collective lower priority level than first user 302a. For example, the system may reassign ticket #4 from first user 302a to third user 304a by a drag and drop or an automated procedure, thereby moving that ticket from box 302 to box 304. However, ticket #4 may be moved to box 303 to reassign to second user 303a or to box 305 to reassign to fourth user 305a in other embodiments of the present disclosure. It should be appreciated that more than one ticket may be moved at any given time.

When management module 30 is in use, the user may evaluate whether to move a ticket to another user by looking at the load scores reflected within each user box. In this embodiment, second user 303a is associated with load score 303b, third user 304a is associated with load score 304b, and fourth user 305a is associated with load score 305b. As tickets are completed or reassigned within the system, the load score associated with a user may change. In some embodiments of the present disclosure, colors may also be associated with load scores similar to as has been described with respect to the status/age of a given ticket and may change as a user's priority level across all tickets assigned to that user changes over time. Thus, using management module 30, auto routing and reassignment of tickets may be performed based upon multiple criteria including but not limited to workload, expertise, and time to completion according to embodiments of the present disclosure.

The management functionality of systems and methods according to embodiments of the present disclosure may provide for auto-organization or sorting of tickets by category. Issue routing to responsible parties also may be provided. Contact information may be managed by systems according to embodiments of the present disclosure by allowing a user to respond or provide information related to a ticket as opposed to directing a response to a specific user. It follows that the assignor of a ticket associated with a task or activity may not even be required to know the user receiving the initial assignment or a reassignment of a task or ticket. In embodiments of the present disclosure, the management functionality may provide the ability to store supporting documents/notes along with an open ticket, and as previously described, a manager or assignor may be able to maintain and review statistics associated with a ticket, including but not limited to task completion, time to completion, as well as number of contacts needed to complete the task. In some embodiments of the present disclosure, the management module also may include a search functionality to allow a user to search across tickets, users, or another parameter.

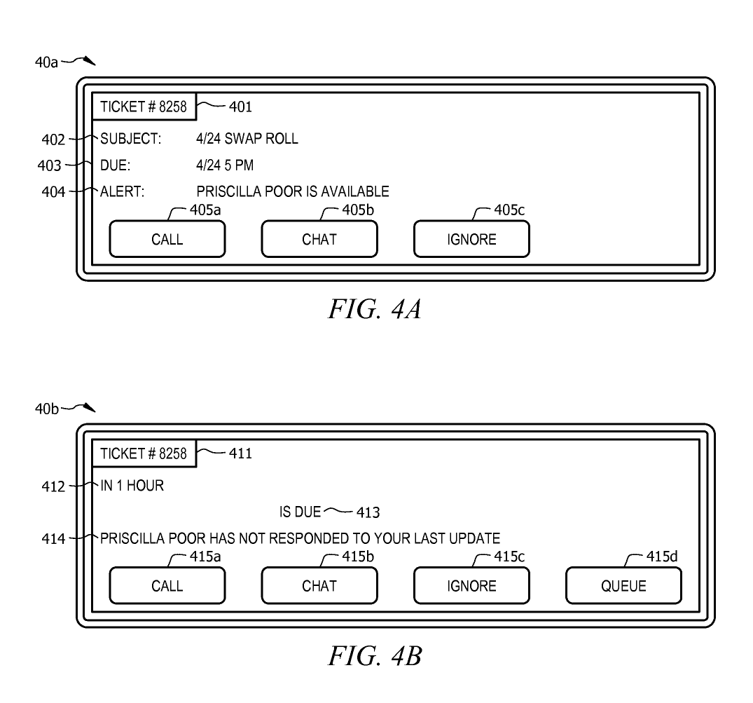

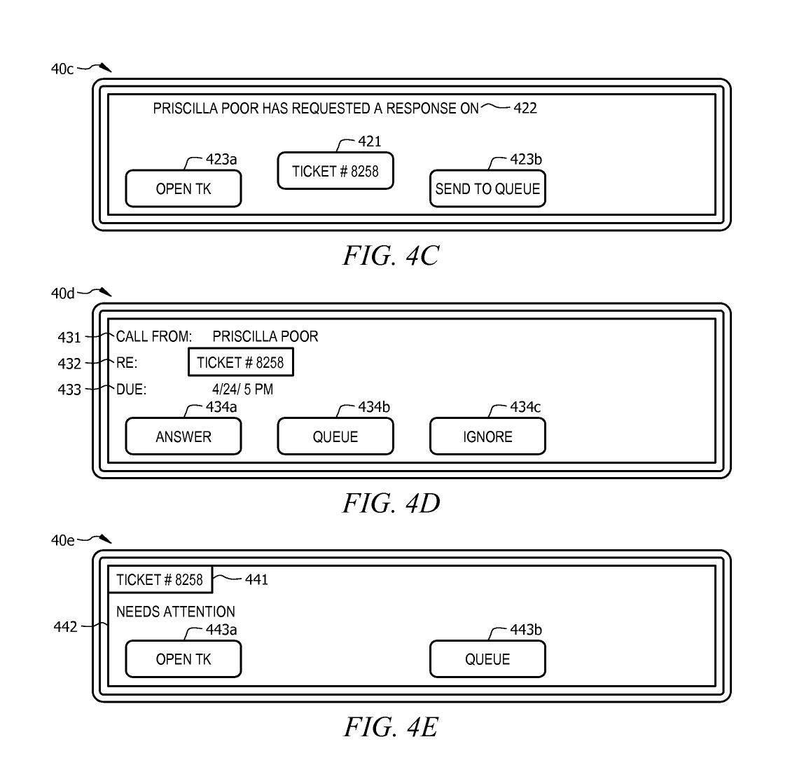

FIGS. 4A-E depict various pop-up windows that the system may provide according to embodiments of the present disclosure. Each of these windows may be tailored to a ticket at issue and/or a particular user or sets of users assigned to the ticket. It should be appreciated that a user assigned to a ticket may view or interact with all, a portion, or none of these pop-up windows during the time that he/she is assigned to a ticket depending on the actions to be taken by that user with respect to the ticket or the issues that may arise with respect to the ticket.

FIG. 4A depicts an embodiment of window 40a that may provide the user with an alert related to a given ticket. In this embodiment, the user may be provided with information including ticket number 401, ticket subject matter 402, ticket due date 403 and alert 404. Alert 404 may include various messages. Perhaps the user viewing window 40a may wish to collaborate with another user (Priscilla Poor), and in this embodiment, alert 404 lets the user know that the other user is available to collaborate. It should be appreciated that other alerts may be made using window 40a without departing from the present disclosure. When the user views window 40a, he/she may be presented with various options on how to respond to alert 404. In this embodiment of the present disclosure, user may select call button 405a to place a call to the other user (Priscilla Poor), select chat button 405b to chat with the other user, or select ignore button 405c if he/she is choosing to ignore the alert, such as due to other obligations. While these three buttons may be depicted in FIG. 4A, it should be appreciated that more or fewer selections may be provided depending on the type of alert or action to be taken according to embodiments of the present disclosure. If a user utilizes one of these selection mechanisms to communicate with another user, and the communication fails (i.e., another user is called but did not answer), the system may log this communication, later determine when that user is available, and then suggest that the user be called to address the ticket according to embodiments of the present disclosure.

FIG. 4B depicts an embodiment of window 40b that may provide the user with an update related to a previous action taken by the user. Window 40b may provide information including ticket number 411, but it also may provide deadline 412 and action 413 that may remind the user that some action is to be completed within a certain time frame with respect to a specified ticket. In this embodiment of the present disclosure, the user is being given an update that the ticket is due to be completed within one hour. Status 414 provides the user with information about the progress (or lack thereof) made with respect to the ticket. In this embodiment, the user is being reminded that the other user that he/she is supposed to collaborate with on the ticket has not responded to the last update. As discussed with respect to FIG. 4A, the user is then presented with various options on how to address the update. In this embodiment, the user may select call button 415a to call the other user, select chat button 415b to attempt to chat with the other user, select ignore button 415c to ignore the status, or select queue button 415d to place the update into his/her queue to be addressed at a later time. While these four buttons or selection mechanisms may be depicted in FIG. 4B, it should be appreciated that more or fewer options may be provided, such as depending on the type of update, according to embodiments of the present disclosure.

FIG. 4C depicts an embodiment of window 40c that may depict a reminder for a user assigned to a ticket. In this embodiment, ticket information 421 may be provided so that the user knows what ticket the reminder is referencing. Reminder 422 may provide the user with information concerning the type of action that has been requested. It should be appreciated that window 40c may appear when the user has selected queue button 415d to place an update in his/her queue to be addressed at a later time. However, there may be other embodiments wherein the user has configured the system to provide reminders within certain time frames following receipt of updates. In this embodiment, the user has been requested to provide a response to another user, and this is reflected in reminder 422. In response to reminder 422, the user may select open ticket button 423a to open the ticket, evaluate the ticket, and provide the response requested. The user also may select send to queue button 423b wherein the user may place the ticket back in his/her queue to be addressed at a later time.

FIG. 4D depicts an embodiment of window 40d that may provide a notification of an incoming communication related to a ticket. In this embodiment, notification 431 may be providing information about a call that has come in related to a given ticket. Subject 432 may vary depending on the type of communication at issue, but it generally should include at least an identification of the ticket (i.e., ticket number) associated with the communication so as to educate the recipient about the subject matter of the incoming communication. In some embodiments of the present disclosure, subject 432 may provide information in addition to the ticket number, such as the subject matter of the ticket at issue. Window 40d also may include due date 433 so that the user may be reminded upon receiving notification 431 the deadline by when action must be taken with respect to the ticket. Window 40d depicts three actions that a user may take—(1) select answer button 434a to answer the call from the other user; (2) select queue button 434b to put the notification in the user's queue as a reminder that it should be addressed later; or (3) select ignore button 434c to decline to answer the call but not put the notification in the queue to be addressed later (such as if the user has already spoken to the other user at the time that the notification is received or he/she is already aware of the subject matter of the incoming call). As previously discussed, the number of action buttons may be more or fewer than are disclosed in FIG. 4D depending on the notification that is being transmitted. For example, the user may receive a chat request from another user, and in such an embodiment, answer button 434a may be substituted with a chat button.

FIG. 4E depicts an embodiment of window 40e that may provide another means to remind a user that action or attention needs to be given to a ticket. Window 40e may provide ticket information 441 which may include the ticket number as well as the subject matter of the ticket as a reminder to the user. Message 442 may be an automated message that pops up if the user has not taken action on a ticket over a specified period of time in an embodiment of the present disclosure. In another embodiment of the present disclosure, message 442 may be transmitted if a ticket or notification remains in the queue without action after a specified period of time has elapsed. While message 442 is depicted as “needs attention” in this embodiment of the present disclosure, it should be appreciated that other messages may be included, and these messages may be limited to a certain number of options or they may be configurable by users. In response to message 442, a user may select open ticket button 443a to review the ticket and determine what attention may need to be given to the ticket. In the alternative, the user may select queue button 443b in order to put the ticket/message back in the user's queue to be addressed at a later time. In some embodiments of the present disclosure, a user may be provided with an option to ignore message 442, but this is less likely insofar as the message would then be lost and action may not be taken in a timely or appropriate manner. As with the action buttons discussed in some embodiments of the present disclosure, there may be more or fewer buttons depicted in window 40e depending on the nature of the ticket or the preferences established by the user. It also should be appreciated that while actions to be taken have been depicted as buttons in these embodiments of the present disclosure, other selection mechanisms may be utilized without departing from the present disclosure.

As depicted in FIGS. 4A-E, embodiments of the present disclosure may provide for inter-system communication via various mechanism including but not limited to email, chat, and phone. These inter-system communications may be associated with one or more tickets within the system and may be retained and attached to each ticket.

In embodiments of the present disclosure, ticket-specific call routing may be provided wherein a central telephone number may be dialed, the ticket number or another identifying number may be entered, and the caller may then be routed to the responsible party associated with that ticket number. It should be appreciated that users may assign contact numbers to tickets so that communications related to a given ticket may be routed, for example, directly to voicemail or to a mobile telephone number. Further, in other embodiments of the present disclosure, the system may be aware when a ticket is open such that when a user calls a central telephone number, the call may be routed to another user performing tasks related to the open ticket without use of a ticket number or another identifying number being entered. In additional embodiments of the present disclosure, routing may be provided through use of caller ID and other similar technologies.

In other embodiments of the present disclosure, if a caller dials the extension of a responsible party associated with a ticket, the caller may receive a message through another form of communication (such as chat or email) with a link to the ticket in order to provide a status update. If a status update is provided, other users associated with the ticket may receive a message within the system to review the update and provide additional comments or input.

In further embodiments of the present disclosure, systems and methods may provide click-to-call communication functionality such that a user may click call, and the system may dial the user and the responding party, and then connect the two calls. In other embodiments, calls may be recorded and the recordings may then be attached to a given ticket. Similarly, a user may create a ticket and then “send” the ticket via a phone call. Accordingly, the ticket may be pushed to other users associated with the ticket upon call connection.

It should be appreciated that, regardless the form of communication, there may be shared and/or hidden attributes associated with a ticket. Accordingly, one user (such as a manager) may be provided with access to see to whom the ticket has been assigned as well as the status of the ticket while another user may only be given access to information relevant to his/her ability to complete the task assigned.

As previously discussed, systems and methods according to embodiments of the present disclosure may provide for interoperability. Interoperability may include but is not limited to standardized data output wherein a webpage or portal may be provided to display information about tickets that may be integrated into an existing CRM for an organization. It should be appreciated that proprietary programs may interact with systems and methods according to embodiments of the present disclosure to create messages and collect responses that may flow back into the proprietary programs. For example, an email may be received with two differing sets of information, and systems according to embodiments of the present disclosure may provide for reconciliation of the differing sets of information by making changes that are directly sent to the sender's system. This may be performed through an Application Programming Interface (API) or other similar technologies according to embodiments of the present disclosure. It also should be appreciated that the systems and methods according to embodiments of the present disclosure may work without dedicated software for users that are not presently “on” the system (i.e., users may reply to notifications related to tickets via email/web communication). Systems and methods according to embodiments of the present disclosure may be made mobile as long as there is a front-end for the database portion of the system.

Systems and methods according to embodiments of the present disclosure may be run as a computer program accessible from a computer-usable or computer-readable medium and/or as web-based application using one or more web servers, processor(s), and one or more databases. Systems and methods according to embodiments of the present disclosure may take the form of software or a combination of hardware and software. It also should be appreciated that users may perform operations related to systems and methods according to embodiments of the present disclosure using one or more desktop or laptop computing devices, centralized computing terminals and/or handheld or wireless devices (such as cellular or smart phones). Accordingly, users may perform operations using one or more input devices, including but not limited to a keyboard, mouse, stylus, track wheel, and/or touch screen.

It should be appreciated that while some of the embodiments have been described with respect to a financial-based environment, systems and methods of workflow automation according to embodiments of the present disclosure are suitable use in organizations requiring complex interactions, particularly where various tasks are to be performed and/or shuffling or reassignment of responsibilities may be needed, including but not limited to legal, engineering, professional services, information technology or sales.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A web-based system for workflow automation comprising:
a relationship window providing an identification of a least one client being managed by the system at a specified time;
a task window displaying information about tasks being performed by users within the system, the tasks being managed by the system;
an open ticket window displaying a listing of open tickets within the system, and
a priority level window to identify the priority level of the tasks assigned to users within the system and to evaluate whether additional tickets should be assigned to a selected user,
wherein each of the windows is populated using information stored in one or more databases accessible via one or more web servers.

2. The system of claim 1 further comprising:
a response window wherein the users respond to address a selected ticket.

3. The system of claim 2 wherein the response window displays at least one ticket number and includes one or more items associated with the at least one ticket number selected from the list comprising:
counterparty, ticket description, contact, status, due date, due time, and ticket age.

4. The system of claim 3 wherein at least one ticket number displayed in the response window is color-coded to reflect the priority level of the ticket associated with the at least one ticket number at the time when a user responds to address the ticket.

5. The system of claim 2, the response window further comprising a text box wherein a user inputs a status message and transmits the message through at least one communication mode selected from the list comprising:
email, phone, text message, and chat.

5. (canceled)

6. The system of claim 1 wherein the open ticket window is organized as a table including a ticket number column and one or more columns selected from the list comprising:
client, ticket description, contact, status, due date, due time, and ticket age.

7. The system of claim 6 wherein the ticket number column is color-coded to reflect the priority of the ticket associated with each ticket number.

8. The system of claim 7 wherein the color-coding correlates to how quickly the deliverable associated with the ticket number is due.

9. The system of claim 7 wherein the color-coding correlates to an estimated amount of time needed to complete the ticket relative to the due date.

10. The system of claim 1 wherein the priority level window identifies one or more users and a status associated with each of the identified one or more users.

11. The system of claim 1 further comprising:
a log window that provides a log of actions taken as to each of the tickets that are open within the system.

12. The system of claim 6 further comprising:
a ticket window accessed by selecting an open ticket within the open ticket window.

13. The system of claim 1 wherein information associated with each of the windows is output to one or more interoperable systems operating external from the system.

14. A computer-based method for workflow automation comprising:
using one or more servers operating within a communication network, generating at least one ticket having at least one categorized task, each of the at least one categorized tasks being assigned a due date for completion and a priority status; and
assigning the ticket to a user based on one or more factors selected from the group comprising:
internal priority, external priority, deadline, what number of contact the user is on, and average time to complete a task relative to the deadline.

15. The method of claim 14 further comprising:
managing metrics related to completion of the at least one categorized task, the metrics comprised of time to completion, number of contacts needed to complete, and types of contacts needed to complete, each of the metrics being stored in one or more databases residing on the one or more servers.

16. The method of claim 15 wherein the managing metrics step comprises:
reassigning the at least one categorized task to a different user based on evaluation of each of the metrics associated with the at least one categorized task.

17. A computer-based method for workflow automation comprising:
using one or more servers, evaluating and changing the priority of the tasks within a user's task list based on workload, availability, expertise, familiarity with other users assigned to the task, and time-to-completion associated with each user assigned to the task,
wherein the user's task list is stored in one or more databases residing on the one or more servers.

18. The method of claim 17 further comprising:
alerting the user to a task within the user's task list; and
providing the user with means to respond to the alert,
the alerting and providing steps being performed through a communication mechanism selected from the group comprising:
electronic mail, text message, phone call, and chat.

19. The method of claim 17 further comprising:
providing one or more communication mechanisms to transmit updates about a task to a user.

20. The method of claim 19 wherein updates are selected from one of the group comprising:
change in due date, change in due time, change in users assigned to the task, change in availability of users assigned to the task, workload of users assigned to the task, activities that have occurred related to the task, and change in task description.
